(19) United States
(12) Patent Application Publication
(10) Pub. No.: US 2008/0035066 A1
(43) Pub. Date: Feb. 14, 2008

(54) All in one pet caddy

(76) Inventors: Ross J. Enriquez, Elk Grove, CA (US); Connie A. Huether, Fargo, ND (US)

Correspondence Address: Ross Enriquez, 9212 Bearint Way, Elk Grove, CA, 95758, US

(21) Appl. No.: 11/503,568

(22) Filed: Aug. 12, 2006

(51) Int. Cl. A01K 5/01

(52) U.S. Cl. 119/61.5

(57) ABSTRACT

The purpose of the Pet Caddy would be to eliminate the pet owner from having to walk throughout the house looking for pet food or for miscellaneous pet items. Thus, making it easier for the pet owner to have all their pet needs in one convenient Pet Caddy. The Pet Caddy can be used inside or outside the home. The Pet Caddy should be made with durable material to tolerate the outside elements. It can be used when camping, on vacations or while traveling. The Pet Caddy should be made in two sizes. 1. To hold a 10 lb. bag of dry pet food for smaller pets, and. 2. To hold a 20 lb. bag of pet food for larger pets. The Front of the Pet Caddy has been left blank leaving room for the pet to walk up to eat and drink. The Rear of the Pet Caddy has a double pouch that would be used for storing the pet leash, pet brush, pet treats etc . . . . The double pouch would be made of soft thin plastic durable material able to weather the outside elements. The top edge of the pouch has elastic so when pulled the opening is stretchable and closes when released. The Inside of the Pet Caddy holds the dry pet food with an airtight seal. The Top of the Pet Caddy is attached to the bottom of the Pet Caddy with screws that fold down when closing. The bowls at the top of the Pet Caddy lock when turned clockwise and unlock when turned counter clockwise to prevent falling during transportation. Between the bowls is a handle to lift the top to gain access to the dry pet food inside. The Bottom of the Pet Caddy has hidden rollers for mobility when cleaning. Both the Right Side and the Left Side of the Pet Caddy each have a lock to secure the top and below the lock is a handle to use for transportation.

We, Ross Enriquez and Connie Huether have invented a new design for a Pet Caddy as set forth the following specifications. The Pet Caddy would be used for feeding and storage of food and pet miscellaneous items.

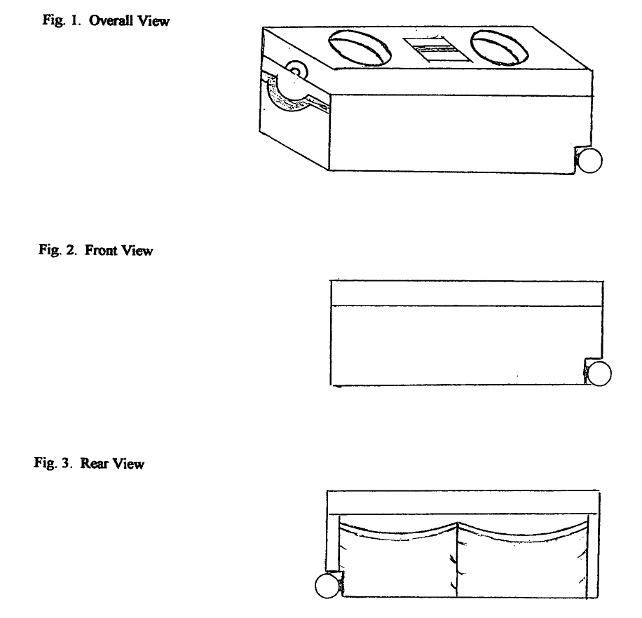

FIG. 1. Is an Overall view of the Pet Caddy; Showing the top and left side of the Pet Caddy.

FIG. 2. Is the Front elevational view thereof; Is blank giving room for the pet to eat and drink.

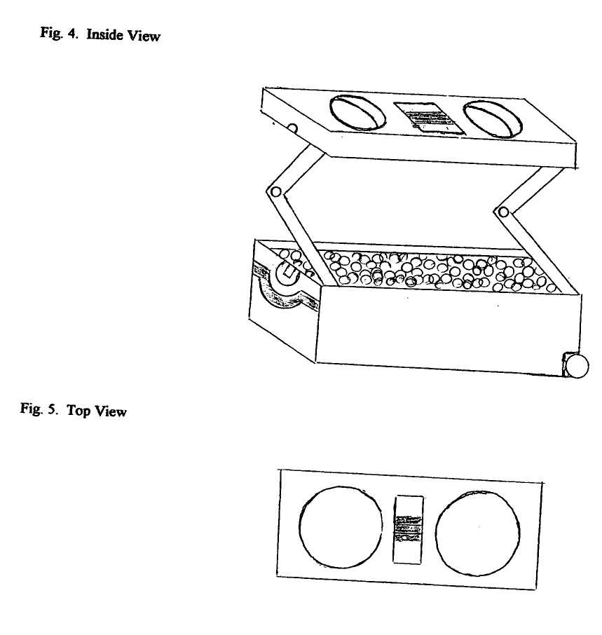

FIG. 3. Is the Rear elevational view thereof; Attached is a double pouch used for storage of pet miscellaneous items.

FIG. 4. Is an Inside elevational view thereof; Stores the dry pet food airtight with a seal keeping the pet food fresh.

FIG. 5. Is a Top plan view thereof; At either side is a bowl for feeding with a handle in the middle to lift the top.

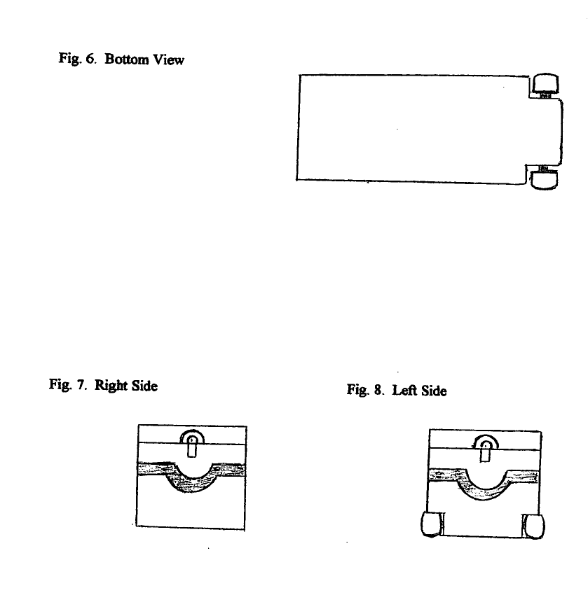

FIG. 6. Is a Bottom plan thereof; Hidden are rollers for mobility while cleaning.

FIG. 7. Is the Right Side elevational view thereof; A lock to secure the top and a handle for transportation. And

FIG. 8. The Left Side elevational view thereof; A lock to secure the top and a handle for transportation.

We claim; The “All in one Pet Caddy”, design as shown.

What we claim as our invention in design and utility to secure by Letters Patent of the United States is as follows:

1. The Pet Caddy box should be made of lightweight durable material able to tolerate the outside elements. The box would measure 24×7×15 in size, allowing a 20 lb. bag of pet food to be stored airtight.

2. The back of the Caddy has a double pouch that holds the pet miscellaneous items. The pouch would be made of soft thin plastic material with an elastic top that is stretchable when pulled and closes when released.

3. The inside of the Caddy has screws that attach the top and the bottom. The screws fold down when closing the top. Inside the Caddy is a seal keeping the pet food airtight.

4. The top of the Caddy has two bowls when turned clockwise lock into place and when turned counter clockwise unlock. Keeping the bowls in place while moving.

5. Underneath the bottom are hidden rollers for mobility while cleaning.

6. The sides of the Caddy have locks to secure the top and a handle for transportation.
Patent coverage for our invention would be to insure that potential infringers will be prevented from making, using, selling or importing our invention even with slight modifications.
